(19) United States
(12) Patent Application Publication
(10) Pub. No.: US 2021/0319138 A1
(43) Pub. Date: Oct. 14, 2021

(54) UTILIZING LOGIC AND SERIAL NUMBER TO PROVIDE PERSISTENT UNIQUE PLATFORM SECRET FOR GENERATION OF SOC ROOT KEYS

(71) Applicant: Intel Corporation, Santa Clara, CA (US)

(72) Inventors: Prashant Dewan, Portland, OR (US); Baiju Patel, Portland, OR (US); Siddhartha Chhabra, Portland, OR (US); Ofir Shwartz, Haifa (IL); Kumar Dwarakanath, Folsom (US)

(73) Assignee: Intel Corporation, Santa Clara, CA (US)

(21) Appl. No.: 17/358,287

(22) Filed: Jun. 25, 2021

(51) Int. Cl. G06F 21/72; G06F 21/79; G06F 21/73; G06F 21/60; G06F 15/78; G06F 7/58

(52) U.S. Cl. CPC G06F 21/72; G06F 21/79; G06F 21/73; G06F 2221/0755; G06F 15/7807; G06F 7/588; G06F 21/602

(57) ABSTRACT

Methods and apparatus relating to utilization of logic and a serial number to provide persistent unique platform secret for generation of System on Chip (SOC or SoC) root keys are described. In an embodiment, stepping logic circuitry generates a stepping identifier in response to a first signal. Unique identifier logic circuitry generates a unique identifier in response to a second signal. Secret generation logic circuitry generates a key based at least in part on the stepping identifier and the unique identifier. The unique identifier is stored in persistent memory. Other embodiments are also disclosed and claimed.

### FIELD

The present disclosure generally relates to the field of electronics. More particularly, an embodiment relates to utilizing deterministic logic and a serial number to provide persistent unique platform secret for generation of System on Chip (SoC or SOC) root keys.

### BACKGROUND

SOC generally refers to an integrated circuit chip that includes all or most components of a computer system or other electronic system. SOC implementations may provide better performance, manufacturing efficiency, power efficiency, etc. The use of SOCs is quickly becoming more commonplace in the computing world.

As SOCs become more widely used in the industry, providing secure SOCs becomes of paramount interest.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an SOC package in accordance with an embodiment.

FIG. 2 illustrates a block diagram of a system to generate a plurality of keys, according to an embodiment.

FIG. 3 illustrates a flow diagram of a method to provide persistent unique platform secret for generation of SOC, according to an embodiment.

FIG. 4 is a block diagram of a processing system, according to an embodiment.

FIG. 5 is a block diagram of an embodiment of a processor having one or more processor cores, according to some embodiments.

FIG. 6 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, providing secure SOCs becomes of paramount interest due to an ever-increasing use of SOCs in the computing industry. However, one fundamental problem with SOC security is the need of a persistent protected secret in the SoC, for encrypting other SoC secrets. SoC secrets may be included in the SOC in the form of metal keys while per-device (e.g., randomly generated) secrets are made persistent in OTP (One-Time Programmable) memories, Electronic Fuses (E-Fuses), IFP (In-Field Programmable) fuses in the SOC. Once stored, these secrets are susceptible to X-ray attacks in the global supply chain and even in the hands of an owner. The fundamental problem in these secrets is that they persist even when the power of the chip is off and lend themselves to various offline attacks.

Moreover, multiple solutions have been explored in the industry to handle these types of attacks. Physically Unclonable Functions (PUFs) are a popular solution for handling these kinds of attacks. Although PUFs provide the security property of non-persistence and random (across devices) generation of the secret, they are hard to realize due to significant aging concerns and a need for Bit Error Rate (BER) recovery in order to handle PUF aging. Although there are PUFs on the market that supply persistent secrets, these PUFs store the secrets instead of generating them at runtime, thereby lowering the security of the solution in favor of reliability.

To this end, some embodiments provide one or more techniques for utilizing (e.g., deterministic) logic and a serial or unique number to provide persistent unique platform secret for generation of SOC root keys. In an embodiment, an SOC (e.g., including deterministic logic) can generate a unique secret per device such that this secret is only available when the SOC is booted and powered and is not persistent in the system. As a result, this secret is not susceptible to any X-Ray attacks since it is never stored where it can be scanned like fuses discussed above. It is also not susceptible to supply chain attacks since the parts of the secret are added to the silicon at different stages in the supply chain in one embodiment. This protects the root secret as well as the derived secret from advanced hardware adversaries. Also, since the secret generation logic circuitry is deterministic, the circuit itself is a secret and is generated in a secret/protected environment.

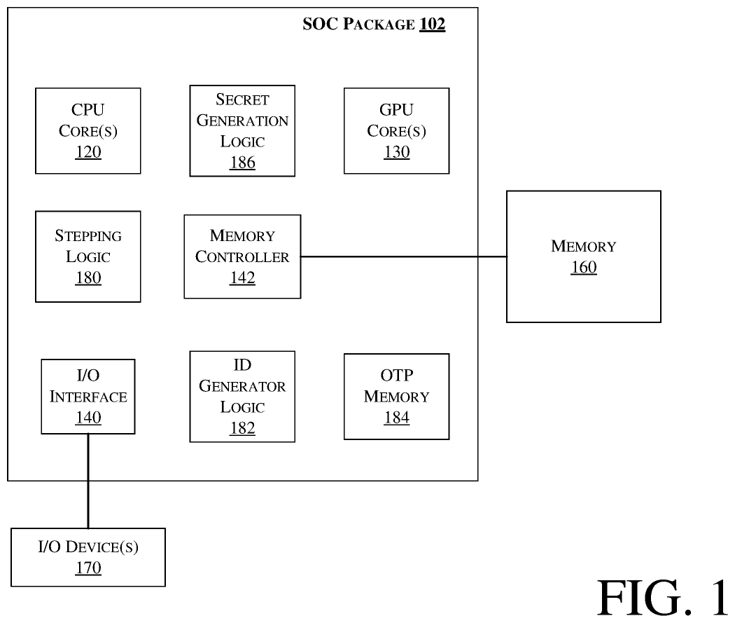

FIG. 1 illustrates a block diagram of an SOC package in accordance with an embodiment. As illustrated in FIG. 1, SOC 102 includes one or more Central Processing Unit (CPU) cores 120, one or more Graphics Processor Unit (GPU) cores 130, an Input/Output (I/O) interface 140, and a memory controller 142. Various components of the SOC package 102 may be coupled to an interconnect or bus such as discussed herein with reference to the other figures. Also, the SOC package 102 may include more or less components, such as those discussed herein. Further, each component of the SOC package 102 may include one or more other components, e.g., as discussed with reference to the other figures herein. In one embodiment, SOC package 102 (and its components) is provided on one or more Integrated Circuit (IC) die, e.g., which are packaged into a single semiconductor device.

As illustrated in FIG. 1, SOC package 102 is coupled to a memory 160 via the memory controller 142. In an embodiment, the memory 160 (or a portion of it) can be integrated on the SOC package 102.

The I/O interface 140 may be coupled to one or more I/O devices 170, e.g., via an interconnect and/or bus such as discussed herein with reference to other figures. I/O device(s) 170 may include one or more of a keyboard, a mouse, a touchpad, a display, an image/video capture device (such as a camera or camcorder/video recorder), a touch screen, a speaker, or the like.

In at least one embodiment, the following two components may be utilized:

(1) a combinatorial and/or deterministic circuit that generates a non-persistent and unique number in response to detection of power/boot and/or a clock signal; this circuit is called a stepping circuit or logic 180 since it is unique per SoC stepping; and/or

(2) random number and/or unique serial identifier (ID) generator logic 182 that generates a per-device serial/unique ID and stores it in the persistent storage, such as an OTP memory 184. Unlike traditional generators, this generator is activated using package pins (on first end user boot up or power on) and is only used once in the lifetime of the silicon. And, if the OTP memory is already written, the Random Number Generator (RNG) generates an error indicating a compromised chip.

Secret Generation logic 186 may then generate a unique platform secret based at least in part on the stepping ID and the unique/serial ID, e.g., by XORing the stepping ID and the unique/serial ID.

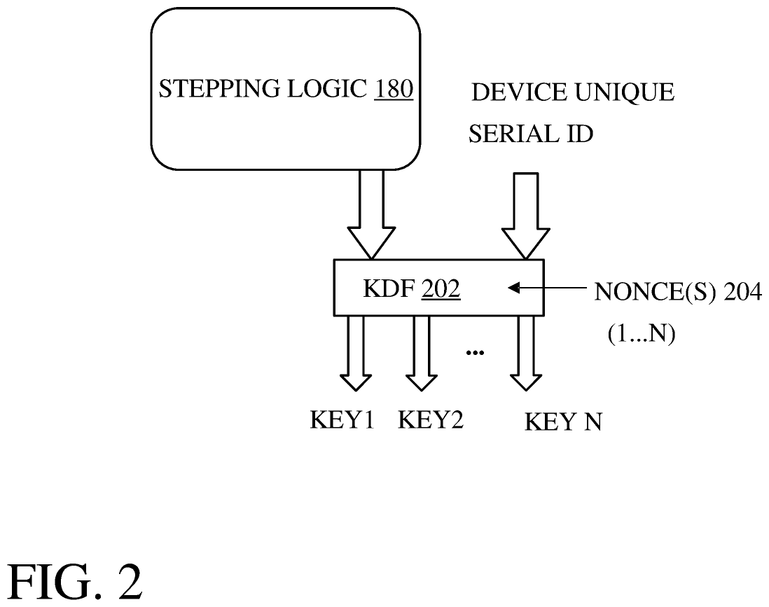

FIG. 2 illustrates a block diagram of a system 200 to generate a plurality of keys, according to an embodiment. A Key Derivation Function (KDF) logic 202 may generate a plurality of keys (key 1, key 2, . . . , key N) base on inputs from a Hardware Security Module (HSM) such as stepping logic 180 and input from the ID generator logic 182 (a device unique serial ID), and a nonce 204. In one embodiment the KDF logic 202 may utilize a National Institute of Standards and Technology (NIST) standard for deriving the keys.

In one embodiment, FIG. 2 illustrates how the solution discussed with reference to FIG. 1 can be further extended to cater to N stages, e.g., in the supply chain. For example, an entity that is in the supply chain can add a (e.g., non-secret) nonce 204 to the chain and receive a unique secret from that device without worrying about the previous (n-1) supply chain entities. The nonce can also be written to the fuses so that the entity downstream cannot change it. The nonce is not a secret. As discussed herein, a nonce in cryptography refers to a number used to protect private communications by preventing replay attacks. Nonces are generally random or pseudo-random numbers that are included in protected communications. As a result, the final SOC secret is determined as follows (such as also shown in FIG. 2):

SOC_SECRET=KDF(root_secret_from_circuit, device_serial_number, n0,n1, n2 . . . N)

where KDF refers to Key Derivation Function, root_secret_from_circuit refers to the unique number that is generated by the stepping circuitry, device_serial_number refers to a unique/serial number for the given device, and n0, n1, n2 . . . N refer to the N stages in the supply chain discussed above.

Accordingly, such embodiments do not need a PUF circuit and they do not need any BER recovery. Also, they do not store the final secret and hence are not exposed to X-ray attacks.

Also, while logic 180/182/186 and memory 184 are shown as components within an SOC package 102, embodiments are not limited to this and one or more of the aforementioned components may be located elsewhere in proximity or otherwise attached/coupled to the SOC package 102.

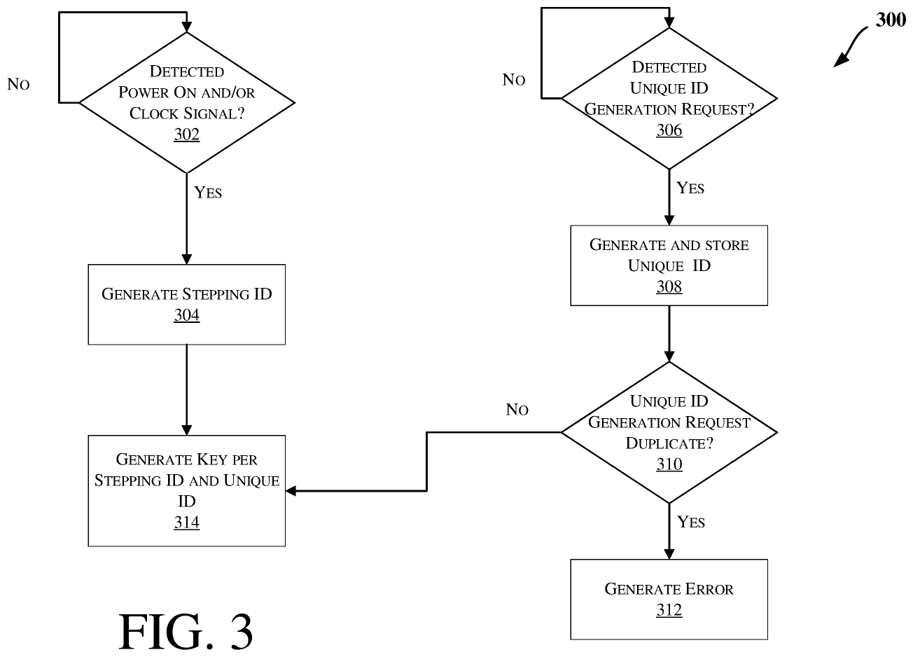

FIG. 3 illustrates a flow diagram of a method 300 to provide persistent unique platform secret for generation of SOC, according to an embodiment. In one or more embodiments, operations of the method 300 may be performed by one of more hardware components of FIGS. 1 and/or 2 as further discussed below.

Referring to FIGS. 1-3, one or more embodiments include:

(A) Deterministic Stepping Circuit 180—This circuit may be added on a per stepping basis in the Register Transfer Level (RTL) (or later GDSII (Graphic Design System II)). When clocked and/or powered at operation 302, this circuit may produce a number (e.g., the same 256-bit (or larger)) number at operation 304. In an embodiment, this circuit is expected to be power gated and/or clock gated most of the time. This 256-bit stepping ID is never released outside the silicon and is never stored inside the silicon in at least one embodiment. As a result, this ID is not exposed to offline X-ray attacks. This circuit can be made even harder to detect by spreading it across different SOC partitions. As the silicon is taped out and sent to foundry, clearly this circuit will be in the GDSII file and determined attacker may be able to identify the circuit, combine the pieces from the netlist and trace the 256 bit stepping ID for that silicon stepping. This adversary will still not have the Serial ID discussed below however. This circuit is automatically generated in a high security environment.

B) Serial ID generation Circuit 182—The serial ID generation circuit may be a Random Number Generator (RNG or Cryptographically Secure Pseudo-Random Number Generator (CSPRNG)) that is activated from an SOC package pin at operation 306. Once activated, this generator circuit generates a (e.g., 256-bit (or larger)) random number and writes it to persistent storage (e.g., in the chip such as OTP memory 184) at operation 308. The random number generated is a per device random number in one embodiment. If the persistent storage is already written to (e.g., as determined at operation 310), a failure may be returned and/or the error is reported through the package pins at operation 312. As previously discussed, in some embodiments, multiple entities in the supply chain can add their own nonce, such that even if the previous entity in the supply chain knew the then current SOC_SECRET, the new SOC_SECRET will be different because of the new nonce in the KDF as shown in FIG. 2.

C) SOC_SECRET—The root secret may be determined by a KDF based on the stepping ID and serial ID. At operation 314, an SOC secret/key is generated (e.g., by secret generation logic 186) based in part on the stepping ID and the unique/serial ID (as well as the nonce(s) in case of multiple entities as discussed above).

Moreover, as the SOC design house generates the netlist for an SOC and sends it to the foundry, the stepping circuit is included in the silicon. A foundry worker can (in theory) extract the DSC and find the stepping ID but there is no way for the foundry worker to obtain the Serial Id of the chip since it is not stored in the chip (when the chip is in foundry). From the foundry, it is sent to the OSAT (Outsourced Semiconductor Assembly and Test). An OSAT employee will find it hard to reverse engineer the circuit since it does not have the netlist but only the wafer. Even if it manages to reverse engineer the wafer, it does not have the serial ID. Hence this employee does not have a way to obtain to the root secret. OSAT slices the chip from the wafer and packages it. Once packaged, the raw silicon is no longer accessible without drilling through the package.

From the OSAT, the chip goes to the device manufacturer. The device manufacturer generally does not have the knowhow to reverse engineer the silicon circuit since it is in the package and the device manufacturer cannot access the silicon since it is embedded in the package. Even if the device manufacturer manages to drill the package and power the circuit and somehow extract the stepping ID, it still does not have the serial ID.

Finally, the device reaches the end user, the end user runs a software or otherwise powers on the device that activates the Serial ID generation circuit 182 and programs a serial ID in the fuses (e.g., OPT memory 184). At this point, the end user has no idea of where the serial ID is stored and has very limited capability of extracting the stepping ID (in one area of the silicon) and the DSC (in another area of the silicon). It is more than likely that while drilling the package to read the stepping ID, the user would damage the power bumps so as to not power the chip up; hence, there will be no easy way of extracting the stepping ID.

Additionally, some embodiments may be applied in computing systems that include one or more processors (e.g., where the one or more processors may include one or more processor cores), such as those discussed with reference to FIG. 1 et seq., including for example a desktop computer, a work station, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

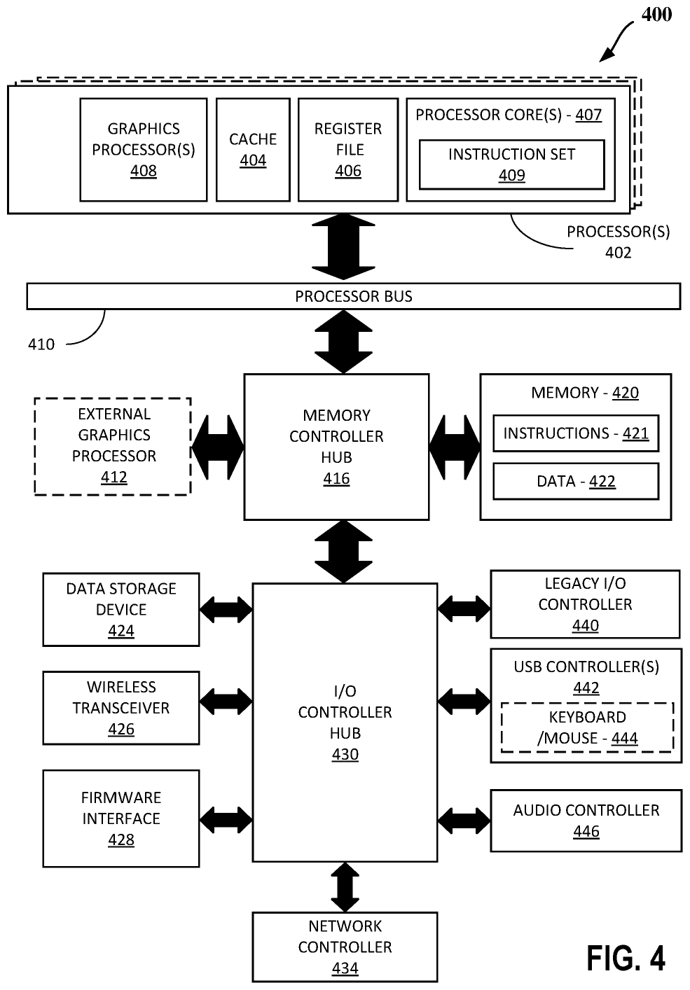

FIG. 4 is a block diagram of a processing system 400, according to an embodiment. In various embodiments the system 400 includes one or more processors 402 and one or more graphics processors 408, and may be a single processor desktop system, a multiprocessor workstation system, or a server system having a large number of processors 402 or processor cores 407. In on embodiment, the system 400 is a processing platform incorporated within a system-on-a-chip (SoC or SOC) integrated circuit for use in mobile, handheld, or embedded devices.

An embodiment of system 400 can include, or be incorporated within a server-based gaming platform, a game console, including a game and media console, a mobile gaming console, a handheld game console, or an online game console. In some embodiments system 400 is a mobile phone, smart phone, tablet computing device or mobile Internet device. Data processing system 400 can also include, couple with, or be integrated within a wearable device, such as a smart watch wearable device, smart eyewear device, augmented reality device, or virtual reality device. In some embodiments, data processing system 400 is a television or set top box device having one or more processors 402 and a graphical interface generated by one or more graphics processors 408.

In some embodiments, the one or more processors 402 each include one or more processor cores 407 to process instructions which, when executed, perform operations for system and user software. In some embodiments, each of the one or more processor cores 407 is configured to process a specific instruction set 409. In some embodiments, instruction set 409 may facilitate Complex Instruction Set Computing (CISC), Reduced Instruction Set Computing (RISC), or computing via a Very Long Instruction Word (VLIW). Multiple processor cores 407 may each process a different instruction set 409, which may include instructions to facilitate the emulation of other instruction sets. Processor core 407 may also include other processing devices, such a Digital Signal Processor (DSP).

In some embodiments, the processor 402 includes cache memory 404. Depending on the architecture, the processor 402 can have a single internal cache or multiple levels of internal cache. In some embodiments, the cache memory is shared among various components of the processor 402. In some embodiments, the processor 402 also uses an external cache (e.g., a Level-3 (L3) cache or Last Level Cache (LLC)) (not shown), which may be shared among processor cores 407 using known cache coherency techniques. A register file 406 is additionally included in processor 402 which may include different types of registers for storing different types of data (e.g., integer registers, floating point registers, status registers, and an instruction pointer register). Some registers may be general-purpose registers, while other registers may be specific to the design of the processor 402.

In some embodiments, processor 402 is coupled to a processor bus 410 to transmit communication signals such as address, data, or control signals between processor 402 and other components in system 400. In one embodiment the system 400 uses an exemplary ‘hub’ system architecture, including a memory controller hub 416 and an Input Output (I/O) controller hub 430. A memory controller hub 416 facilitates communication between a memory device and other components of system 400, while an I/O Controller Hub (ICH) 430 provides connections to I/O devices via a local I/O bus. In one embodiment, the logic of the memory controller hub 416 is integrated within the processor.

Memory device 420 can be a dynamic random access memory (DRAM) device, a static random access memory (SRAM) device, flash memory device, phase-change memory device, or some other memory device having suitable performance to serve as process memory. In one embodiment the memory device 420 can operate as system memory for the system 400, to store data 422 and instructions 421 for use when the one or more processors 402 executes an application or process. Memory controller hub 416 also couples with an optional external graphics processor 412, which may communicate with the one or more graphics processors 408 in processors 402 to perform graphics and media operations.

In some embodiments, ICH 430 enables peripherals to connect to memory device 420 and processor 402 via a high-speed I/O bus. The I/O peripherals include, but are not limited to, an audio controller 446, a firmware interface 428, a wireless transceiver 426 (e.g., Wi-Fi, Bluetooth), a data storage device 424 (e.g., hard disk drive, flash memory, etc.), and a legacy I/O controller 440 for coupling legacy (e.g., Personal System 2 (PS/2)) devices to the system. One or more Universal Serial Bus (USB) controllers 442 connect input devices, such as keyboard and mouse 444 combinations. A network controller 434 may also couple to ICH 430. In some embodiments, a high-performance network controller (not shown) couples to processor bus 410. It will be appreciated that the system 400 shown is exemplary and not limiting, as other types of data processing systems that are differently configured may also be used. For example, the I/O controller hub 430 may be integrated within the one or more processor 402, or the memory controller hub 416 and I/O controller hub 430 may be integrated into a discreet external graphics processor, such as the external graphics processor 412.

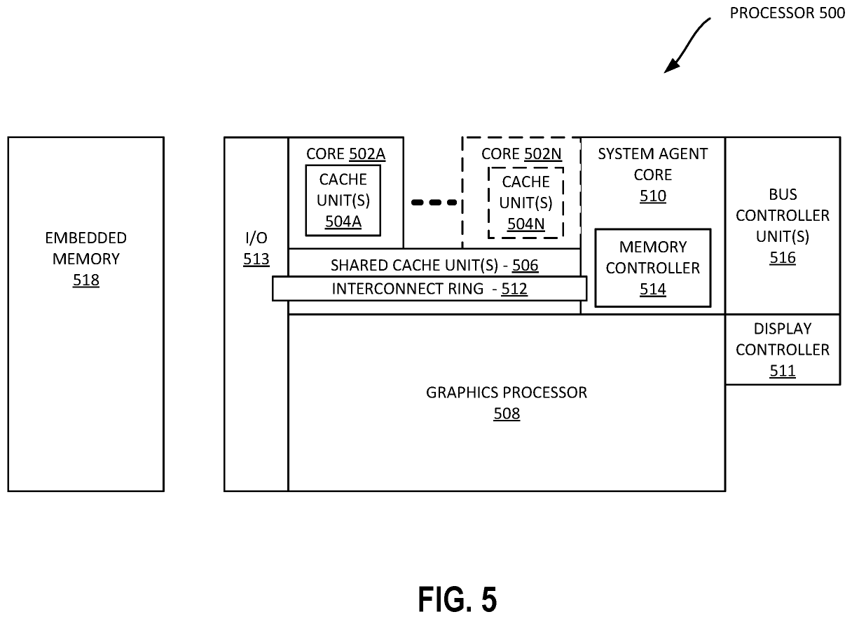

FIG. 5 is a block diagram of an embodiment of a processor 500 having one or more processor cores 502A to 502N, an integrated memory controller 514, and an integrated graphics processor 508. Those elements of FIG. 5 having the same reference numbers (or names) as the elements of any other figure herein can operate or function in any manner similar to that described elsewhere herein, but are not limited to such. Processor 500 can include additional cores up to and including additional core 502N represented by the dashed lined boxes. Each of processor cores 502A to 502N includes one or more internal cache units 504A to 504N. In some embodiments each processor core also has access to one or more shared cached units 506.

The internal cache units 504A to 504N and shared cache units 506 represent a cache memory hierarchy within the processor 500. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 506 and 504A to 504N.

In some embodiments, processor 500 may also include a set of one or more bus controller units 516 and a system agent core 510. The one or more bus controller units 516 manage a set of peripheral buses, such as one or more Peripheral Component Interconnect buses (e.g., PCI, PCI Express). System agent core 510 provides management functionality for the various processor components. In some embodiments, system agent core 510 includes one or more integrated memory controllers 514 to manage access to various external memory devices (not shown).

In some embodiments, one or more of the processor cores 502A to 502N include support for simultaneous multi-threading. In such embodiment, the system agent core 510 includes components for coordinating and operating cores 502A to 502N during multi-threaded processing. System agent core 510 may additionally include a power control unit (PCU), which includes logic and components to regulate the power state of processor cores 502A to 502N and graphics processor 508.

In some embodiments, processor 500 additionally includes graphics processor 508 to execute graphics processing operations. In some embodiments, the graphics processor 508 couples with the set of shared cache units 506, and the system agent core 510, including the one or more integrated memory controllers 514. In some embodiments, a display controller 511 is coupled with the graphics processor 508 to drive graphics processor output to one or more coupled displays. In some embodiments, display controller 511 may be a separate module coupled with the graphics processor via at least one interconnect, or may be integrated within the graphics processor 508 or system agent core 510.

In some embodiments, a ring based interconnect unit 512 is used to couple the internal components of the processor 500. However, an alternative interconnect unit may be used, such as a point-to-point interconnect, a switched interconnect, or other techniques, including techniques well known in the art. In some embodiments, graphics processor 508 couples with the ring interconnect 512 via an I/O link 513.

The exemplary I/O link 513 represents at least one of multiple varieties of I/O interconnects, including an on package I/O interconnect which facilitates communication between various processor components and a high-performance embedded memory module 518, such as an eDRAM (or embedded DRAM) module. In some embodiments, each of the processor cores 502 to 502N and graphics processor 508 use embedded memory modules 518 as a shared Last Level Cache.

In some embodiments, processor cores 502A to 502N are homogenous cores executing the same instruction set architecture. In another embodiment, processor cores 502A to 502N are heterogeneous in terms of instruction set architecture (ISA), where one or more of processor cores 502A to 502N execute a first instruction set, while at least one of the other cores executes a subset of the first instruction set or a different instruction set. In one embodiment processor cores 502A to 502N are heterogeneous in terms of microarchitecture, where one or more cores having a relatively higher power consumption couple with one or more power cores having a lower power consumption. Additionally, processor 500 can be implemented on one or more chips or as an SoC integrated circuit having the illustrated components, in addition to other components.

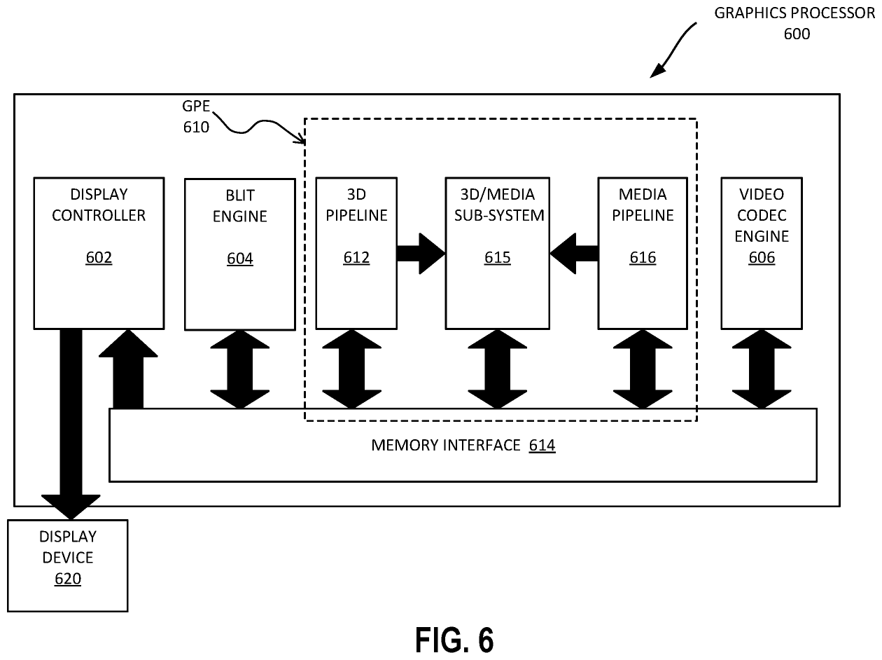

FIG. 6 is a block diagram of a graphics processor 600, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 600 includes a memory interface 614 to access memory. Memory interface 614 can be an interface to local memory, one or more internal caches, one or more shared external caches, and/or to system memory.

In some embodiments, graphics processor 600 also includes a display controller 602 to drive display output data to a display device 620. Display controller 602 includes hardware for one or more overlay planes for the display and composition of multiple layers of video or user interface elements. In some embodiments, graphics processor 600 includes a video codec engine 606 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 600 includes a block image transfer (BLIT) engine 604 to perform two-dimensional (2D) rasterizer operations including, for example, bit-boundary block transfers. However, in one embodiment, 3D graphics operations are performed using one or more components of graphics processing engine (GPE) 610. In some embodiments, graphics processing engine 610 is a compute engine for performing graphics operations, including three-dimensional (3D) graphics operations and media operations.

In some embodiments, GPE 610 includes a 3D pipeline 612 for performing 3D operations, such as rendering three-dimensional images and scenes using processing functions that act upon 3D primitive shapes (e.g., rectangle, triangle, etc.). The 3D pipeline 612 includes programmable and fixed function elements that perform various tasks within the element and/or spawn execution threads to a 3D/Media sub-system 615. While 3D pipeline 612 can be used to perform media operations, an embodiment of GPE 610 also includes a media pipeline 616 that is specifically used to perform media operations, such as video post-processing and image enhancement.

In some embodiments, media pipeline 616 includes fixed function or programmable logic units to perform one or more specialized media operations, such as video decode acceleration, video de-interlacing, and video encode acceleration in place of, or on behalf of video codec engine 606. In some embodiments, media pipeline 616 additionally includes a thread spawning unit to spawn threads for execution on 3D/Media sub-system 615. The spawned threads perform computations for the media operations on one or more graphics execution units included in 3D/Media sub-system 615.

In some embodiments, 3D/Media subsystem 615 includes logic for executing threads spawned by 3D pipeline 612 and media pipeline 616. In one embodiment, the pipelines send thread execution requests to 3D/Media subsystem 615, which includes thread dispatch logic for arbitrating and dispatching the various requests to available thread execution resources. The execution resources include an array of graphics execution units to process the 3D and media threads. In some embodiments, 3D/Media subsystem 615 includes one or more internal caches for thread instructions and data. In some embodiments, the subsystem also includes shared memory, including registers and addressable memory, to share data between threads and to store output data.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: stepping logic circuitry to generate a stepping identifier in response to a first signal; unique identifier logic circuitry to generate a unique identifier in response to a second signal; and secret generation logic circuitry to generate a key based at least in part on the stepping identifier and the unique identifier, wherein the unique identifier is to be stored in persistent memory. Example 2 includes the apparatus of example 1, wherein the unique identifier logic circuitry is to generate the unique identifier as a random number. Example 3 includes the apparatus of example 1, wherein the first signal is to be activated in response to a power on and/or a clock signal. Example 4 includes the apparatus of example 1, wherein the first signal is to be asserted in response to activation of a pin. Example 5 includes the apparatus of example 1, wherein a system on chip comprises the persistent memory, wherein the first signal is to be asserted in response to activation of a pin of the system on chip. Example 6 includes the apparatus of example 1, wherein the secret generation logic circuitry is to generate the key based at least in part on a Key Derivation Function (KDF) operation to be performed on the stepping identifier and the unique identifier. Example 7 includes the apparatus of example 1, wherein the secret generation logic circuitry is to generate a plurality of keys based at least in part on the stepping identifier, the unique identifier, and a plurality of nonces. Example 8 includes the apparatus of example 1, wherein storage of the stepping identifier in non-volatile memory is disallowed. Example 9 includes the apparatus of example 1, wherein the persistent memory comprises one or more of: a one-time programmable memory, an electronic fuse, and an in-field programmable fuse. Example 10 includes the apparatus of example 1, wherein the unique identifier is a per-device unique identifier. Example 11 includes the apparatus of example 1, wherein, after the unique identifier is stored in the persistent memory, any subsequent requests to generate a new unique identifier is rejected. Example 12 includes the apparatus of example 1, wherein the secret generation logic circuitry is to be generated in a secret environment.

Example 13 includes one or more computer-readable medium comprising one or more instructions that when executed on at least one processor configure the at least one processor to perform one or more operations to cause: stepping logic circuitry to generate a stepping identifier in response to a first signal; unique identifier logic circuitry to generate a unique identifier in response to a second signal; and secret generation logic circuitry to generate a key based at least in part on the stepping identifier and the unique identifier, wherein the unique identifier is to be stored in persistent memory. Example 14 includes the one or more computer-readable medium of example 13, further comprising one or more instructions that when executed on the at least one processor configure the at least one processor to perform one or more operations to cause the unique identifier logic circuitry to generate the unique identifier as a random number. Example 15 includes the one or more computer-readable medium of example 13, further comprising one or more instructions that when executed on the at least one processor configure the at least one processor to perform one or more operations to cause activation of the first signal in response to a power on and/or a clock signal. Example 16 includes the one or more computer-readable medium of example 13, further comprising one or more instructions that when executed on the at least one processor configure the at least one processor to perform one or more operations to cause assertion of the first signal in response to activation of a pin. Example 17 includes the one or more computer-readable medium of example 13, further comprising one or more instructions that when executed on the at least one processor configure the at least one processor to perform one or more operations to cause assertion of the first signal in response to activation of a pin of a system on chip, wherein a system on chip comprises the persistent memory. Example 18 includes the one or more computer-readable medium of example 13, further comprising one or more instructions that when executed on the at least one processor configure the at least one processor to perform one or more operations to cause the secret generation logic circuitry to generate the key based at least in part on a Key Derivation Function (KDF) operation to be performed on the stepping identifier and the unique identifier. Example 19 includes the one or more computer-readable medium of example 13, further comprising one or more instructions that when executed on the at least one processor configure the at least one processor to perform one or more operations to cause the secret generation logic circuitry to generate a plurality of keys based at least in part on the stepping identifier, the unique identifier, and a plurality of nonces. Example 20 includes the one or more computer-readable medium of example 13, further comprising one or more instructions that when executed on the at least one processor configure the at least one processor to perform one or more operations to cause disallowance of storage of the stepping identifier in non-volatile memory. Example 21 includes the one or more computer-readable medium of example 13, wherein the persistent memory comprises one or more of: a one-time programmable memory, an electronic fuse, and an in-field programmable fuse. Example 22 includes the one or more computer-readable medium of example 13, wherein the unique identifier is a per-device unique identifier.

Example 23 includes a method comprising: causing stepping logic circuitry to generate a stepping identifier in response to a first signal; causing unique identifier logic circuitry to generate a unique identifier in response to a second signal; and causing secret generation logic circuitry to generate a key based at least in part on the stepping identifier and the unique identifier, wherein the unique identifier is stored in persistent memory. Example 24 includes the method of example 23, further comprising causing the unique identifier logic circuitry to generate the unique identifier as a random number. Example 25 includes the method of example 23, further comprising causing activation of the first signal in response to a power on and/or a clock signal.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In various embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
stepping logic circuitry to generate a stepping identifier in response to a first signal;
unique identifier logic circuitry to generate a unique identifier in response to a second signal; and
secret generation logic circuitry to generate a key based at least in part on the stepping identifier and the unique identifier,
wherein the unique identifier is to be stored in persistent memory.

2. The apparatus of claim 1, wherein the unique identifier logic circuitry is to generate the unique identifier as a random number.

3. The apparatus of claim 1, wherein the first signal is to be activated in response to a power on and/or a clock signal.

4. The apparatus of claim 1, wherein the first signal is to be asserted in response to activation of a pin.

5. The apparatus of claim 1, wherein a system on chip comprises the persistent memory, wherein the first signal is to be asserted in response to activation of a pin of the system on chip.

6. The apparatus of claim 1, wherein the secret generation logic circuitry is to generate the key based at least in part on a Key Derivation Function (KDF) operation to be performed on the stepping identifier and the unique identifier.

7. The apparatus of claim 1, wherein the secret generation logic circuitry is to generate a plurality of keys based at least in part on the stepping identifier, the unique identifier, and a plurality of nonces.

8. The apparatus of claim 1, wherein storage of the stepping identifier in non-volatile memory is disallowed.

9. The apparatus of claim 1, wherein the persistent memory comprises one or more of:
a one-time programmable memory, an electronic fuse, and an in-field programmable fuse.

10. The apparatus of claim 1, wherein the unique identifier is a per-device unique identifier.

11. The apparatus of claim 1, wherein, after the unique identifier is stored in the persistent memory, any subsequent requests to generate a new unique identifier is rejected.

12. The apparatus of claim 1, wherein the secret generation logic circuitry is to be generated in a secret environment.

13. One or more computer-readable medium comprising one or more instructions that when executed on at least one processor configure the at least one processor to perform one or more operations to cause:
stepping logic circuitry to generate a stepping identifier in response to a first signal;
unique identifier logic circuitry to generate a unique identifier in response to a second signal; and
secret generation logic circuitry to generate a key based at least in part on the stepping identifier and the unique identifier,
wherein the unique identifier is to be stored in persistent memory.

14. The one or more computer-readable medium of claim 13, further comprising one or more instructions that when executed on the at least one processor configure the at least one processor to perform one or more operations to cause the unique identifier logic circuitry to generate the unique identifier as a random number.

15. The one or more computer-readable medium of claim 13, further comprising one or more instructions that when executed on the at least one processor configure the at least one processor to perform one or more operations to cause activation of the first signal in response to a power on and/or a clock signal.

16. The one or more computer-readable medium of claim 13, further comprising one or more instructions that when executed on the at least one processor configure the at least one processor to perform one or more operations to cause assertion of the first signal in response to activation of a pin.

17. The one or more computer-readable medium of claim 13, further comprising one or more instructions that when executed on the at least one processor configure the at least one processor to perform one or more operations to cause assertion of the first signal in response to activation of a pin of a system on chip, wherein a system on chip comprises the persistent memory.

18. The one or more computer-readable medium of claim 13, further comprising one or more instructions that when executed on the at least one processor configure the at least one processor to perform one or more operations to cause the secret generation logic circuitry to generate the key based at least in part on a Key Derivation Function (KDF) operation to be performed on the stepping identifier and the unique identifier.

19. The one or more computer-readable medium of claim 13, further comprising one or more instructions that when executed on the at least one processor configure the at least one processor to perform one or more operations to cause the secret generation logic circuitry to generate a plurality of keys based at least in part on the stepping identifier, the unique identifier, and a plurality of nonces.

20. The one or more computer-readable medium of claim 13, further comprising one or more instructions that when executed on the at least one processor configure the at least one processor to perform one or more operations to cause disallowance of storage of the stepping identifier in non-volatile memory.

21. The one or more computer-readable medium of claim 13, wherein the persistent memory comprises one or more of: a one-time programmable memory, an electronic fuse, and an in-field programmable fuse.

22. The one or more computer-readable medium of claim 13, wherein the unique identifier is a per-device unique identifier.

23. A method comprising:
causing stepping logic circuitry to generate a stepping identifier in response to a first signal;
causing unique identifier logic circuitry to generate a unique identifier in response to a second signal; and
causing secret generation logic circuitry to generate a key based at least in part on the stepping identifier and the unique identifier,
wherein the unique identifier is stored in persistent memory.

24. The method of claim 23, further comprising causing the unique identifier logic circuitry to generate the unique identifier as a random number.

25. The method of claim 23, further comprising causing activation of the first signal in response to a power on and/or a clock signal.
